(19) United States
(12) Patent Application Publication
(10) Pub. No.: US 2024/0381944 A1
(43) Pub. Date: Nov. 21, 2024

(54) AEROSOL GENERATING DEVICE

(71) Applicant: KT&G CORPORATION, Daejeon (KR)

(72) Inventors: Byungsung CHO, Gwangmyung-si Gyeonggi-do (KR); Jongsub LEE, Sungnam-si Gyeonggi-do (KR); Sangkyu PARK, Seoul (KR); Wooseok CHUNG, Namyangju-si Gyeonggi-do (KR); Daenam HAN, Seoul (KR)

(73) Assignee: KT&G CORPORATION, Daejeon (KR)

(21) Appl. No.: 18/696,586

(22) PCT Filed: Oct. 14, 2022
(86) PCT No.: PCT/KR2022/015653

§ 371 Date: Mar. 28, 2024

(30) Foreign Application Priority Data
Oct. 20, 2021 (KR) 10-2021-0140328
Mar. 3, 2022 (KR) 10-2022-0027572

(51) Int. Cl. A24F 40/57; A24F 40/46; A24F 40/53; H01M 50/581; H01M 50/583; H05B 1/02

(52) U.S. Cl. CPC A24F 40/57; A24F 40/46; A24F 40/53; H01M 50/581; H01M 50/583; H05B 1/0202; H01M 2200/101; H01M 2200/103; H01M 2200/108; H01M 2220/30

(57) ABSTRACT

An aerosol generating device is provided. The aerosol generating device includes: a housing; a heater to heat an aerosol generating substance; a battery to supply power to the heater; and a temperature switch to switch an electrical connection between the heater and the battery, wherein the temperature switch includes a first switch terminal that is positioned to electrically couple to a first heater terminal of the heater and a second switch terminal that is positioned to electrically couple to a first battery terminal of the battery, wherein the temperature switch is bent in a direction when the temperature switch is heated to or above a first temperature, and wherein the first switch terminal is spaced apart from the first heater terminal after the temperature switch is bent in the direction to electrically open the coupling of the first switch terminal to the first heater terminal.

### TECHNICAL FIELD

The present disclosure relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE

### Technical Problem

It is an objective of the present disclosure to solve the above and other problems.

It is another objective of the present disclosure to provide an aerosol generating device that can cut off the supply of power to a heater based on the remaining amount of aerosol generating substance.

It is yet another objective of the present disclosure to provide an aerosol generating device that can prevent overheating of a heater when the remaining amount of aerosol generating substance is insufficient.

### Technical Solution

According to one aspect of the subject matter described in this application, an aerosol generating device includes: a housing; a heater configured to heat an aerosol generating substance; a battery configured to supply power to the heater; and a temperature switch configured to switch an electrical connection between the heater and the battery, wherein the temperature switch includes a first switch terminal that is positioned to electrically couple to a first heater terminal of the heater and a second switch terminal that is positioned to electrically couple to a first battery terminal of the battery, wherein the temperature switch is bent in a direction when the temperature switch is heated to or above a first temperature, and wherein the first switch terminal is spaced apart from the first heater terminal after the temperature switch is bent in the direction to electrically open the coupling of the first switch terminal to the first heater terminal.

According to another aspect of the subject matter described in this application, an aerosol generating device includes: a heater configured to heat an aerosol generating substance; a battery configured to supply power to the heater to enable the heater to heat the aerosol generating substance; a temperature switch configured to switch an electrical connection between the heater and the battery; and a housing that is shaped to include the heater, the battery and the temperature switch, wherein the temperature switch comprises: a first switch terminal electrically coupled to a first heater terminal of the heater when the temperature switch is in a first orientation; and a second switch terminal that is positioned to electrically couple to a first battery terminal of the battery when the temperature switch is in the first orientation, wherein the temperature switch is bent, relative to the first orientation, when the temperature switch is heated to exceed a temperature threshold, and wherein while the temperature switch is bent, the first switch terminal is spaced from the first heater terminal to electrically open the coupling of the first switch terminal to the first heater terminal.

### Advantageous Effects

According to at least one of the embodiments of the present disclosure, the supply of power to a heater may be cut off based on the remaining amount of aerosol generating substance.

According to at least one of the embodiments of the present disclosure, overheating of a heater may be prevented when the remaining amount of aerosol generating substance is insufficient.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### DESCRIPTION OF DRAWINGS

FIG. 1 is a block diagram illustrating an example of an aerosol generating device.

FIGS. 2 to 4 are views referenced to describe examples of an aerosol generating device.

FIGS. 5 to 7 are views referenced to describe examples of a stick.

FIG. 8 is a view illustrating an example of a structure of an aerosol generating device.

FIGS. 9 to 14 are views referenced to describe examples of an aerosol generating device.

### BEST MODE

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

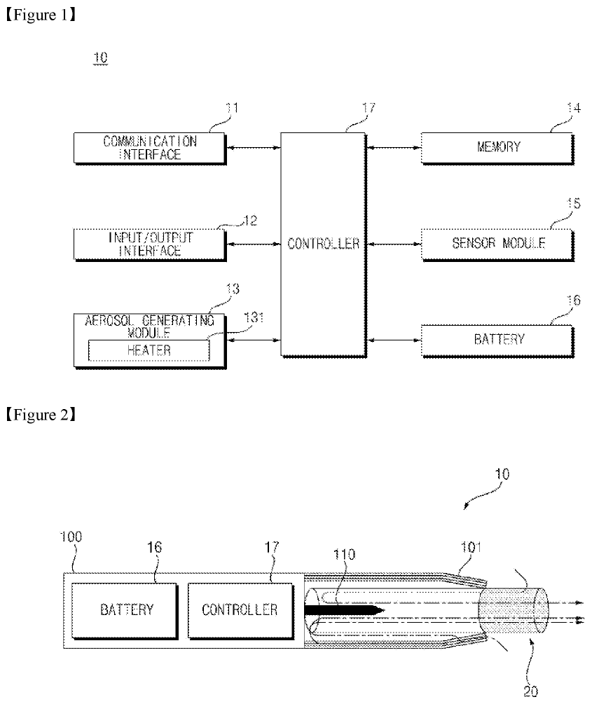

FIG. 1 is a block diagram of an aerosol generating device according to an embodiment of the present disclosure.

Referring to FIG. 1, an aerosol generating device 10 may include a communication interface 11, an input/output interface 12, an aerosol generating module 13, a memory 14, a sensor module 15, a battery 16, and/or a controller 17.

In one embodiment, the aerosol generating device 10 may consist of only a body 100. In this case, components included in the aerosol generating device 10 may be disposed in the body 100. In another embodiment, the aerosol generating device 10 may consist of a cartridge 200, which contains an aerosol generating substance, and a body 100. In this case, components included in the aerosol generating device 10 may be disposed in at least one of the body 100 and the cartridge 200.

The communication interface 11 may include at least one communication module for communication with an external device and/or a network. For example, the communication interface 11 may include a communication module for wired communication such as a Universal Serial Bus (USB). For example, the communication interface 11 may include a communication module for wireless communication such as Wireless Fidelity (Wi-Fi), Bluetooth, Bluetooth Low Energy (BLE), ZigBee, or Near-Field Communication (NFC).

The input/output interface 12 may include an input device for receiving a command from a user and/or an output device for outputting information to the user. For example, the input device may include a touch panel, a physical button, a microphone, etc. For example, the output device may include a display device for outputting visual information, such as a display or a light-emitting diode (LED), an audio device for outputting auditory information, such as a speaker or a buzzer, a motor for outputting tactile information, such as a haptic effect, etc.

The input/output interface 12 may transmit data corresponding to a command input by the user through the input device to another component (or other components) of the aerosol generating device 10. The input/output interface 12 may output information corresponding to data received from another component (or other components) of the aerosol generating device 10 through the output device.

The aerosol generating module 13 may generate an aerosol from an aerosol generating substance. Here, the aerosol generating substance may be a substance in a liquid state, a solid state, or a gel state, which can produce an aerosol, or a combination of two or more aerosol generating substances.

In one embodiment, the liquid aerosol generating substance may be a liquid including a tobacco-containing material having a volatile tobacco flavor component. In another embodiment, the liquid aerosol generating substance may be a liquid including a non-tobacco material. For example, the liquid aerosol generating substance may include water, solvents, nicotine, plant extracts, flavorings, flavoring agents, vitamin mixtures, etc.

The solid aerosol generating substance may include a solid material based on a tobacco raw material such as a reconstituted tobacco sheet, shredded tobacco, or granulated tobacco. In addition, the solid aerosol generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol generating substance may further include an aerosol forming agent such as glycerin or propylene glycol.

The aerosol generating module 13 may include at least one heater 131.

The aerosol generating module 13 may include an electro-resistive heater. For example, the electro-resistive heater may include at least one electrically conductive track. The electro-resistive heater may be heated by the current flowing through the electrically conductive track. Here, the aerosol generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may have any one of a tubular shape, a plate shape, a needle shape, a rod shape, and a coil shape.

The aerosol generating module 13 may include a heater that uses an induction-heating method, namely, an induction heater. For example, the induction heater may include an electrically conductive coil. The induction heater may generate an alternating magnetic field, which periodically changes in direction, by adjusting the current flowing through the electrically conductive coil. In this case, when the alternating magnetic field is applied to a magnetic body, energy loss may occur in the magnetic body due to eddy current loss and hysteresis loss, and the lost energy may be released as thermal energy. Accordingly, the aerosol generating substance located adjacent to the magnetic body may be heated. Here, an object that generates heat due to the magnetic field may be referred to as a susceptor.

Meanwhile, the aerosol generating module 13 may generate ultrasonic vibrations to thereby produce an aerosol from the aerosol generating substance.

The aerosol generating module 13 may be referred to as a cartomizer, an atomizer, or a vaporizer.

When the aerosol generating device 10 consists of a cartridge 200 containing an aerosol generating substance, and a body 100, the aerosol generating module 13 may be disposed in at least one of the body 100 and the cartridge 200.

The memory 14 may store therein programs for processing and controlling each signal in the controller 17. The memory 14 may store therein data processed and data to be processed by the controller 17.

For example, the memory 14 may store therein applications designed for the purpose of performing various tasks that can be processed by the controller 17. For example, the memory 14 may selectively provide some of the stored applications in response to a request from the controller 17.

For example, the memory 14 may store therein data regarding an operation time of the aerosol generating device 10, the maximum number of puffs, the current number of puffs, at least one temperature profile, a user's inhalation pattern, charging/discharging, etc. Here, the “puff(s)” may refer to inhalation by the user, and the “inhalation” may refer to the user's act of taking air or other substances into the user's oral cavity, nasal cavity, or lungs through the user's mouth or nose.

The memory 14 may include at least one of volatile memory (e.g., dynamic random access memory (DRAM), static random access memory (SRAM), and synchronous dynamic random access memory (SDRAM)), nonvolatile memory (e.g., flash memory), a hard disk drive (HDD), and a solid-state drive (SSD).

The sensor module 15 may include at least one sensor.

For example, the sensor module 15 may include a sensor for sensing a puff (hereinafter referred to as a “puff sensor”). Here, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a temperature of the heater 131 included in the aerosol generating module 13 and a temperature of the aerosol generating substance (hereinafter referred to as a “temperature sensor”).

In this case, the heater 131 included in the aerosol generating module 13 may serve as the temperature sensor. For example. the electro-resistive material of the heater 131 may be a material having a temperature coefficient of resistance (TCR). The sensor module 15 may measure the resistance of the heater 131, which varies according to temperature, to thereby sense the temperature of the heater 131.

For example, when a stick is capable of being inserted into the body 100 of the aerosol generating device 10, the sensor module 15 may include a sensor for sensing insertion of the stick (hereinafter referred to as a “stick detection sensor”).

For example, when the aerosol generating device 10 includes a cartridge 200, the sensor module 15 may include a sensor for sensing mounting/removal (or attachment/detachment) of the cartridge 200 to/from the body 100 and a position of the cartridge 200 (hereinafter referred to as a “cartridge detection sensor”).

In this case, the stick detection sensor and/or the cartridge detection sensor may be implemented as an inductance-based sensor, a capacitance sensor, a resistance sensor, or a Hall IC using a Hall effect. In some embodiments, the cartridge detection sensor may include a connection terminal. The connection terminal may be provided in the body 100. As the cartridge 200 is coupled to the body 100, the connection terminal may be electrically connected to electrodes disposed in the cartridge 200. The connection terminal may also serve as the cartridge detection sensor. For example, the sensor module 15 may detect mounting/removal of the cartridge 200 to/from the body 100 based on a current flowing through the connection terminal, a voltage applied to the connection terminal, etc.

For example, the sensor module 15 may include a voltage sensor for sensing a voltage applied to a component (e.g., the battery 16) provided in the aerosol generating device 10 and/or a current sensor for sensing a current.

For example, the sensor module 15 may include at least one sensor for sensing the movement of the aerosol generating device 10 (hereinafter referred to as a “motion sensor”). Here, the motion sensor may be implemented as at least one of a gyro sensor and an acceleration sensor.

The battery 16 may supply power used for the operation of the aerosol generating device 10 under the control of the controller 17. The battery 16 may supply power to other components provided in the aerosol generating device 10. For example, the battery 16 may supply power to the communication module included in the communication interface 11, the output device included in the input/output interface 12, and the heater 131 included in the aerosol generating module 13.

The battery 16 may be a rechargeable battery or a disposable battery. For example, the battery 16 may be a lithium-ion battery or a lithium polymer (Li-polymer) battery, but is not limited thereto. For example, when the battery 16 is rechargeable, a charge rate (C-rate) of the battery 16 may be 10C, and a discharge rate (C-rate) thereof may be 10C to 20C. However, the present disclosure is not limited thereto. In addition, for stable use, the battery 16 may be designed to retain 80% or more of its original capacity at 2,000 full charge and discharge cycles.

The aerosol generating device 10 may further include a battery protection circuit module (PCM), which is a circuit for protecting the battery 16. The battery protection circuit module (PCM) may be disposed adjacent to an upper surface of the battery 16. For example, in order to prevent overcharging and overdischarging of the battery 16, the battery protection circuit module (PCM) may cut off an electrical path to the battery 16 when a short circuit occurs in a circuit connected to the battery 16, when an overvoltage is applied to the battery 16, or when an excessive current flows through the battery 16.

The aerosol generating device 10 may further include a charging terminal to which power supplied from the outside is input. For example, the charging terminal may be provided at one side of the body 100 of the aerosol generating device 10. The aerosol generating device 10 may charge the battery 16 using the power supplied through the charging terminal. In this case, the charging terminal may be configured as a wired terminal for USB communication, a pogo pin, or the like.

The aerosol generating device 10 may wirelessly receive power supplied from the outside through the communication interface 11. For example, the aerosol generating device 10 may wirelessly receive power using an antenna included in the communication module for wireless communication. For example, the aerosol generating device 10 may charge the battery 16 using the wirelessly supplied power.

The controller 17 may control the overall operation of the aerosol generating device 10. The controller 17 may be connected to each of the components provided in the aerosol generating device 10. The controller 17 may transmit and/or receive a signal to and/or from each of the components, thereby controlling the overall operation of each of the components.

The controller 17 may include at least one processor. The controller 17 may control the overall operation of the aerosol generating device 10 through the processor included therein. Here, the processor may be a general processor such as a central processing unit (CPU). Alternatively, the processor may be a dedicated device such as an application-specific integrated circuit (ASIC) or any of other hardware-based processors.

The controller 17 may perform any one of a plurality of functions of the aerosol generating device 10. For example, the controller 17 may perform any one of a plurality of functions of the aerosol generating device 10 (e.g., a preheating function, a heating function, a charging function, and a cleaning function) according to the state of each of the components provided in the aerosol generating device 10, a user command received through the input/output interface 12, and the like.

The controller 17 may control the operation of each of the components provided in the aerosol generating device 10 based on data stored in the memory 14. For example, the controller 17 may control such that predetermined power is supplied from the battery 16 to the aerosol generating module 13 for a predetermined time based on data stored in the memory 14 such as the temperature profile and the user's inhalation pattern.

The controller 17 may determine the occurrence or non-occurrence of a puff through the puff sensor included in the sensor module 15. For example, the controller 17 may check a temperature change, a flow change, a pressure change, and a voltage change in the aerosol generating device 10 based on values sensed by the puff sensor. For example, the controller 17 may determine the occurrence or non-occurrence of a puff according to the result of checking based on a value sensed by the puff sensor.

The controller 17 may control the operation of each of the components provided in the aerosol generating device 10 according to the occurrence or non-occurrence of a puff and/or the number of puffs. For example, the controller 17 may control the temperature of the heater 131 to be changed or maintained based on the temperature profile stored in the memory 14.

The controller 17 may control such that the supply of power to the heater 131 is interrupted according to a predetermined condition. For example, the controller 17 may control such that the supply of power to the heater 131 is cut off when the stick is removed, when the cartridge 200 is removed, when the number of puffs reaches the predetermined maximum number of puffs, when a puff is not sensed for a predetermined time or longer, or when the remaining capacity of the battery 16 is less than a predetermined value.

The controller 17 may calculate the remaining capacity (hereinafter referred to as the “remaining amount of power”) with respect to the full charge capacity of the battery 16. For example, the controller 17 may calculate the remaining amount of power of the battery 16 based on a value sensed by the voltage sensor and/or the current sensor included in the sensor module 15.

The controller 17 may control such that power is supplied to the heater 131 using at least one of a pulse width modulation (PWM) method and a proportional-integral-differential (PID) method.

For example, the controller 17 may control such that a current pulse having a predetermined frequency and a predetermined duty ratio is supplied to the heater 131 using the PWM method. In this case, the controller 17 may control power supplied to the heater 131 by adjusting the frequency and the duty ratio of the current pulse.

For example, the controller 17 may determine a target temperature to be controlled based on the temperature profile. In this case, the controller 17 may control power supplied to the heater using the PID method, which is a feedback control method using a difference value between the temperature of the heater 131 and the target temperature, a value obtained by integrating the difference value with respect to time, and a value obtained by differentiating the difference value with respect to time.

For example, the controller 17 may control power supplied to the heater 131 based on the temperature profile. The controller 17 may control a length of a heating section for heating the heater 131, the amount of power supplied to the heater 131 during the heating section, and the like. The controller 17 may control the power supplied to the heater 131 based on the target temperature of the heater 131.

Although the PWM method and the PID method are described as exemplary methods of controlling the supply of power to the heater 131, the present disclosure is not limited thereto. Other various control methods, such as a proportional-integral (PI) method and a proportional-differential (PD) method, may also be used.

The controller 17 may determine a temperature of the heater 131, and may adjust the amount of power supplied to the heater 131 according to the temperature of the heater 131. For example, the controller 17 may determine the temperature of the heater 131 by checking a resistance value of the heater 131, a current flowing through the heater 131, and/or a voltage applied to the heater 131.

Meanwhile, the controller 17 may control such that power is supplied to the heater 131 according to a predetermined condition. For example, when a cleaning function for cleaning a space into which a stick is inserted is selected according to a command input by the user through the input/output interface 12, the controller 17 may control such that predetermined power is supplied to the heater 131.

FIGS. 2 to 4 are views for explaining an aerosol generating device according to embodiments of the present disclosure.

According to various embodiments of the present disclosure, the aerosol generating device 10 may include a body 100 and/or a cartridge 200.

Referring to FIG. 2, the aerosol generating device 10 according to this embodiment may include a body 100 configured to allow a stick 20 to be inserted into a space defined by a housing 101 thereof.

The stick 20 may be similar to a general combustive cigarette. For example, the stick 20 may be divided into a first part including an aerosol generating substance and a second part including a filter and the like. Alternatively, the second part of the stick 20 may also include an aerosol generating substance. For example, an aerosol generating substance made in the form of granules or capsules may be inserted into the second part.

The entire first part may be inserted into the aerosol generating device 10, and the second part may be exposed to the outside. Alternatively, only a portion of the first part may be inserted into the aerosol generating device 10, or portions of the first part and the second part may be inserted into the aerosol generating device 10. A user may inhale an aerosol while holding the second part in his or her mouth. As outside or external air passes through the first part, an aerosol may be generated, and the generated aerosol may pass through the second part to be delivered to the mouth of the user.

The body 100 may have a structure that allows external air to be introduced therein with the stick 20 inserted. Here, the external air introduced into the body 100 may pass through the stick 20 to flow into the mouth of the user.

A heater may be disposed in the body 100 at a position corresponding to a position at which the stick 20 is inserted into the body 100. Although the heater in FIG. 2 is illustrated as an electrically conductive heater 110 including an electrically conductive track of a needle-shape, the present disclosure is not limited thereto.

The heater may heat an inside and/or outside of the stick 20 by using power supplied from the battery 16. In this case, an aerosol may be generated in the heated stick 20. Here, the user may puff on one end of the stick 20 with his or her mouth to inhale a tobacco-flavored aerosol.

Meanwhile, according to a predetermined condition, the controller 17 may control such that power is supplied to the heater even when the stick 20 is not inserted into the body 100. For example, when a cleaning function for cleaning the space into which the stick 20 is inserted is selected according to a command input by the user through the input/output interface 12, the controller 17 may control predetermined power to be supplied to the heater.

The controller 17 may monitor the number of puffs upon insertion of the stick 20 into the body 10 based on a value sensed by the puff sensor.

When the inserted stick 20 is removed from the body 100, the controller 17 may initialize the current number of puffs stored in the memory 14.

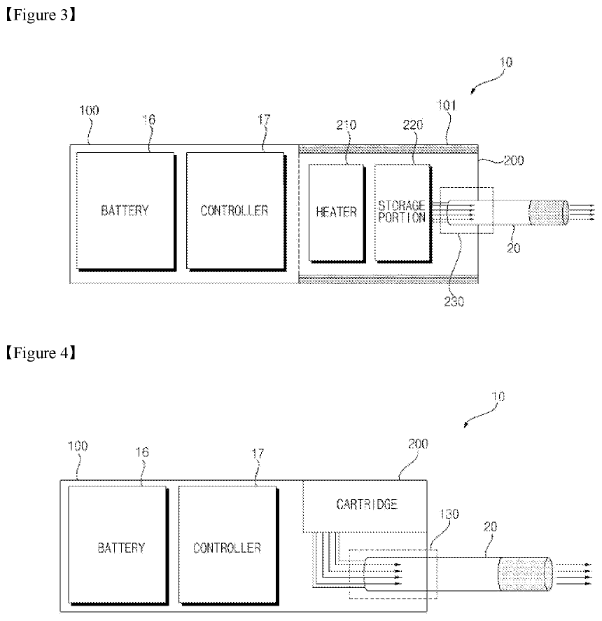

Referring to FIG. 3, the aerosol generating device 10 according to this embodiment may include a body 100 that supports a cartridge 200 and the cartridge 200 that contains an aerosol generating substance.

In one embodiment, the cartridge 200 may be configured to be detachably attached to the body 100. In another embodiment, the cartridge 200 may be integrally formed with the body 100. For example, at least a portion of the cartridge 200 may be inserted into an inner space defined by a housing 101 of the body 100, allowing the cartridge 200 to be mounted to the body 100.

The body 100 may have a structure that allows external air to be introduced therein with the cartridge 200 inserted. Here, the external air introduced into the body 100 may pass through the cartridge 200 to flow into the mouth of the user.

The controller 17 may determine mounting/removal of the cartridge 200 to/from the body 100 through the cartridge detection sensor included in the sensor module 15. For example, the cartridge detection sensor may transmit a pulse current through one terminal connected to the cartridge 200. In this case, the cartridge detection sensor may detect connection or disconnection of the cartridge 200 based on whether the pulse current is received through another terminal.

The cartridge 200 may include a heater 210 that heats an aerosol generating substance and/or a storage portion 220 that stores the aerosol generating substance. For example, a liquid delivery element impregnated with (containing) the aerosol generating substance may be disposed in the storage portion 220. An electrically conductive track of the heater 210 may have a structure wound around the liquid delivery element. As the liquid delivery element is heated by the heater 210, an aerosol may be produced. Here, the liquid delivery element may be a wick such as cotton fiber, ceramic fiber, glass fiber, or porous ceramic.

The cartridge 200 may include an insertion space 230 configured to allow a stick 20 to be inserted therein. For example, the cartridge 200 may include an insertion space defined by an inner wall (not shown) extending in a circumferential direction along a direction in which the stick 20 is inserted. Here, an inside of the inner wall may be open vertically to define the insertion space. The stick 20 may be inserted into the insertion space 230 defined by the inner wall.

The insertion space into which the stick 20 is inserted may have a shape corresponding to a shape of a portion of the stick 20 inserted into the insertion space. For example, when the stick 20 has a cylindrical shape, the insertion space may be formed in a cylindrical shape.

When the stick 20 is inserted into the insertion space, an outer circumferential surface of the stick 20 may be surrounded by the inner wall to be in contact with the inner wall.

A portion of the stick 20 may be inserted into the insertion space 230 of the cartridge 200, and the remaining portion may be exposed to the outside.

The user may inhale an aerosol while holding one end of the stick 20 in his or her mouth. An aerosol generated by the heater 210 may pass through the stick 20 to be delivered to the mouth of the user. Here, a material included in the stick 20 may be added to the aerosol while passing through the stick 20, and the material-added aerosol may be inhaled into the mouth of the user through the one end of the stick 20.

Referring to FIG. 4, the aerosol generating device 10 according to this embodiment may include a body 100 that supports a cartridge 200 and the cartridge 200 that contains an aerosol generating substance. The body 100 may be configured such that a stick 20 is insertable into an insertion space 130.

The aerosol generating device 10 may include a first heater configured to heat the aerosol generating substance stored in the cartridge 200. For example, when a user puffs on one end of the stick 20 with his or her mouth, an aerosol generated by the first heater may pass through the stick 20. Here, a flavoring may be added to the aerosol while passing through the stick 20. The flavored aerosol may be inhaled into the mouth of the user through the one end of the stick 20.

In another embodiment, the aerosol generating device 10 may include a heater configured to heat the aerosol generating substance stored in the cartridge 200 and a heater configured to heat the stick 20 inserted into the body 100. For example, the aerosol generating device 10 may generate an aerosol by heating the aerosol generating substance stored in the cartridge 200 and the stick 20 through the plurality of heaters, respectively.

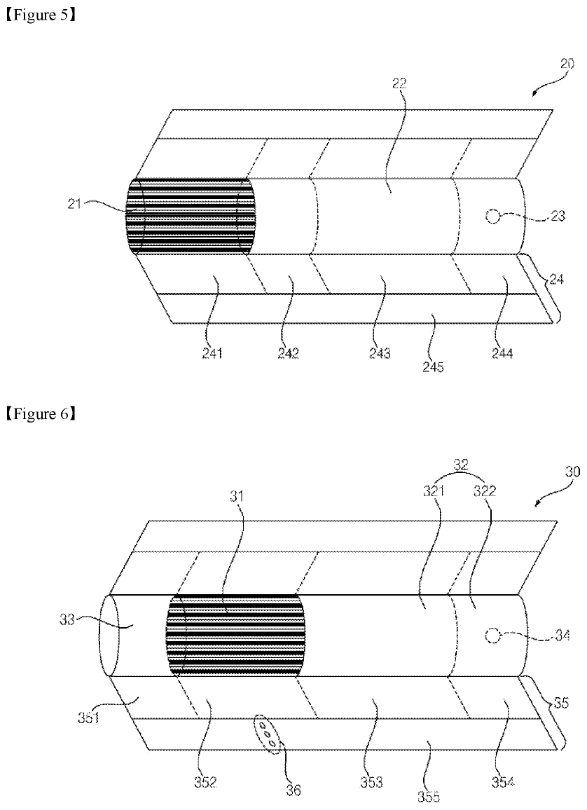

FIGS. 5 to 7 are views for explaining a stick according to embodiments of the present disclosure. Overlapping descriptions in FIGS. 5 to 7 will be omitted.

Referring to FIG. 5, a stick 20 according to this embodiment may include a tobacco rod 21 and a filter rod 22. The first part described above with reference to FIG. 2 may include the tobacco rod 21. The second part described above with reference to FIG. 2 may include the filter rod 22.

The filter rod 22 in FIG. 5 is shown as a single segment but is not limited thereto. In other words, the filter rod 22 may include a plurality of segments. For example, the filter rod 22 may include a first segment for cooling an aerosol and a second segment for filtering a predetermined component included in the aerosol. In addition, when necessary, the filter rod 22 may further include at least one segment performing another function.

A diameter of the stick 20 may be in a range of 5 μmm to 9 μmm, and a length of the stick 20 may be about 48 μmm. However, the present disclosure is not limited thereto. For example, a length of the tobacco rod 21 may be about 12 μmm, a length of the first segment of the filter rod 22 may be about 10 μmm, a length of the second segment of the filter rod 22 may be about 14 μmm, and a length of a third segment of the filter rod 22 may be about 12 μmm. However, the present disclosure is not limited thereto.

The stick 20 may be wrapped by at least one wrapper 24. The wrapper 24 may have at least one hole through which external air is introduced or internal gas is discharged. In one example, the stick 20 may be wrapped by one wrapper 24. In another example, the stick 20 may be wrapped by two or more wrappers 24 in an overlapping manner. For example, the tobacco rod 21 may be wrapped by a first wrapper 241. For example, the filter rod 22 may be wrapped by second wrappers 242, 243, and 244. The tobacco rod 21 and the filter rod 22, which are wrapped by the respective wrappers, may be coupled to each other. The entire stick 20 may be rewrapped by a third wrapper 245. When the filter rod 22 consists of a plurality of segments, each of the segments may be wrapped by an individual wrapper (242, 243, 244). In addition, the entire stick 20 in which the segments respectively wrapped by the individual wrappers are coupled to one another may be rewrapped by another wrapper.

The first wrapper 241 and the second wrapper 242 may be made of general filter wrapping paper. For example, the first wrapper 241 and the second wrapper 242 may be porous wrappers or non-porous wrappers. In addition, the first wrapper 241 and the second wrapper 242 may be made of paper and/or an aluminum laminate packaging material with oil resistance.

The third wrapper 243 may be made of hard wrapping paper. For example, a basis weight of the third wrapper 243 may be in a range of 88 g/m² to 96 g/m². For example, a basis weight of the third wrapper 243 may be in a range of 90 g/m² to 94 g/m². In addition, a thickness of the third wrapper 243 may be in a range of 120 μm to 130 μm. For example, the thickness of the third wrapper 243 may be 125 μm.

The fourth wrapper 244 may be made of oil-resistant hard wrapping paper. For example, a basis weight of the fourth wrapper 244 may be in a range of 88 g/m² to 96 g/m². For example, a basis weight of the fourth wrapper 244 may be in a range of 90 g/m² to 94 g/m². In addition, a thickness of the fourth wrapper 244 may be in a range of 120 μm to 130 μm. For example, the thickness of the fourth wrapper 244 may be 125 μm.

The fifth wrapper 245 may be made of sterile paper (MFW). Here, the sterile paper (MFW) may refer to paper specially designed to have improved tensile strength, water resistance, smoothness, and the like compared to general paper. For example, a basis weight of the fifth wrapper 245 may be in a range of 57 g/m² to 63 g/m². For example, a basis weight of the fifth wrapper 245 may be 60 g/m². In addition, a thickness of the fifth wrapper 245 may be in a range of 64 μm to 70 μm. For example, the thickness of the fifth wrapper 245 may be 67 μm.

A predetermined material may be added into the fifth wrapper 245. Here, an example of the predetermined material may be silicone, but is not limited thereto. For example, silicone may have properties such as heat resistance having little change with temperature, oxidation resistance, resistance to various chemicals, water repellency to water, electrical insulation, etc. However, other than the silicone, any material having the above-described properties may be applied onto or coated on the fifth wrapper 245.

The fifth wrapper 245 may prevent combustion of the stick 20. For example, when the tobacco rod 21 is heated by the heater 110, there may exist a possibility of combustion of the stick 20. In detail, when the temperature rises above the ignition point of any one of the materials included in the tobacco rod 21, the stick 20 may be combustible. However, as the fifth wrapper 245 includes a non-combustible material, the combustion of the stick 20 may be prevented.

In addition, the fifth wrapper 245 may prevent the body 100 from being contaminated by materials generated in the stick 20. Liquid materials may be generated in the stick 20 due to a puff by a user. For example, as an aerosol produced in the stick 20 is cooled by external air, liquids (e.g., moisture, etc.) may be generated. As the stick 20 is wrapped by the fifth wrapper 245, the liquids generated in the stick 20 may be prevented from leaking out of the stick 20.

The tobacco rod 21 may include an aerosol generating substance. For example, the aerosol generating substance may include, but is not limited to, at least one of glycerin, propylene glycol, ethylene glycol, dipropylene glycol, diethylene glycol, triethylene glycol, tetraethylene glycol, and oleyl alcohol. Also, the tobacco rod 21 may contain other additives such as a flavoring agent, a wetting agent, and/or an organic acid. In addition, a flavoring liquid, such as menthol or humectant, may be added to the tobacco rod 21 by being sprayed onto the tobacco rod 21.

The tobacco rod 21 may be manufactured in various ways. For example, the tobacco rod 21 may be formed as a sheet. For example, the tobacco rod 21 may be formed as strands. For example, the tobacco rod 21 may be formed as shredded tobacco obtained by finely cutting a tobacco sheet. For example, the tobacco rod 21 may be surrounded by a heat conductive material. For example, the heat conductive material may be a metal foil such as aluminum foil, but is not limited thereto. For example, the heat conductive material surrounding the tobacco rod 21 may evenly distribute heat transferred to the tobacco rod 21 to thereby increase conduction of the heat applied to the tobacco rod 21. As a result, the taste of tobacco may be improved. The heat conductive material surrounding the tobacco rod 21 may serve as a susceptor heated by an induction heater. Although not shown in the drawing, the tobacco rod 21 may further include an additional susceptor, in addition to the heat conductive material surrounding an outside thereof.

The filter rod 22 may be a cellulose acetate filter. Moreover, the filter rod 22 is not limited to a particular shape. For example, the filter rod 22 may be a cylinder type rod. For example, the filter rod 22 may be a tube type rod including a hollow therein. For example, the filter rod 22 may be a recess type rod. When the filter rod 22 consists of a plurality of segments, at least one of the plurality of segments may have a different shape from the others.

The first segment of the filter rod 22 may be a cellulose acetate filter. For example, the first segment may be a tube-shaped structure including a hollow therein. The first segment may prevent an inner material of the tobacco rod 21 from being pushed back upon insertion of the heater 110, and may provide the effect of cooling an aerosol. A diameter of the hollow included in the first segment may be appropriately determined or selected in a range of 2 μmm to 4.5 μmm, but is not limited thereto.

A length of the first segment may be appropriately determined in a range of 4 μmm to 30 μmm, but is not limited thereto. For example, the length of the first segment may be 10 μmm, but is not limited thereto.

The second segment of the filter rod 22 cools an aerosol generated when the heater 110 heats the tobacco rod 21. Thus, the user may inhale an aerosol cooled to an appropriate temperature.

A length or diameter of the second segment may be variously determined according to the shape of the stick 20. For example, the length of the second segment may be appropriately selected in a range of 7 μmm to 20 μmm. More preferably, the length of the second segment may be about 14 μmm, but is not limited thereto.

The second segment may be made by weaving polymer fibers. In this case, a flavoring liquid may be applied to a fiber made of polymers. Alternatively, the second segment may be made by weaving a separate fiber coated with a flavoring liquid and a fiber made of polymers together. Alternatively, the second segment may be made of a crimped polymer sheet.

For example, a polymer may be made of a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is made of the woven polymer fiber or the crimped polymer sheet, the second segment may include a single channel or a plurality of channels extending in a longitudinal direction. Here, the “channel” may refer to a passage through which gas (e.g., air or aerosol) passes.

For example, the second segment made of a crimped polymer sheet may be made from a material having a thickness between 5 μm and 300 μm, namely, between 10 μm and 250 μm. Also, a total surface area of the second segment may be between 300 μmm²/mm and 1000 μmm²/mm. In addition, an aerosol cooling element may be made from a material with a specific surface area between 10 μmm²/mg and 100 μmm²/mg.

Meanwhile, the second segment may include a thread containing a volatile flavor component. Here, the volatile flavor component may be menthol, but is not limited thereto. For example, the thread may be filled with a sufficient amount of menthol to provide at least 1.5 μmg of menthol to the second segment.

The third segment of the filter rod 22 may be a cellulose acetate filter. A length of the third segment may be appropriately selected in a range of 4 μmm to 20 μmm. For example, the length of the third segment may be about 12 μmm, but is not limited thereto.

The filter rod 22 may be manufactured to generate flavor. In one example, a flavoring liquid may be sprayed onto the filter rod 22. In another example, a separate fiber coated with a flavoring liquid may be inserted into the filter rod 22.

In addition, the filter rod 22 may include at least one capsule 23. Here, the capsule 23 may perform a function of generating flavor. The capsule 23 may also perform a function of generating an aerosol. For example, the capsule 23 may have a structure in which a liquid containing a flavoring material is wrapped with a film. The capsule 23 may have a spherical or cylindrical shape, but is not limited thereto.

Referring to FIG. 6, a stick 30 according to this embodiment may further include a front-end plug 33. The front-end plug 33 is disposed on one side opposite a filter rod 32 with respect to a tobacco rod 31. The front-end plug 33 may prevent the tobacco rod 31 from being separated to the outside. The front-end plug 33 may prevent a liquefied aerosol from flowing into the aerosol generating device 10 from the tobacco rod 31 while smoking.

The filter rod 32 may include a first segment 321 and a second segment 322. The first segment 321 may correspond to the first segment of the filter rod 22 of FIG. 5. The second segment 322 may correspond to the third segment of the filter rod 22 of FIG. 5.

A diameter and an overall length of the stick 30 may correspond to the diameter and the overall length of the stick 20 of FIG. 5. For example, a length of the front-end plug 33 may be about 7 μmm, a length of the tobacco rod 31 may be about 15 μmm, a length of the first segment 321 may be about 12 μmm, and a length of the second segment 322 may be about 14 μmm. However, the present disclosure is not limited thereto.

The stick 30 may be wrapped by at least one wrapper 35. The wrapper 35 may have at least one hole through which external air is introduced or internal gas is discharged. For example, the front-end plug 33 may be wrapped by a first wrapper 351, the tobacco rod 31 may be wrapped by a second wrapper 352, the first segment 321 may be wrapped by a third wrapper 353, and the second segment 322 may be wrapped by a fourth wrapper 354. Then, the entire stick 30 may be rewrapped by a fifth wrapper 355.

In addition, the fifth wrapper 355 may have at least one perforation 36. For example, the perforation 36 may be formed in an area surrounding the tobacco rod 31, but is not limited thereto. For example, the perforation 36 may serve to transfer heat generated by the heater 210 of FIG. 3 to an inside of the tobacco rod 31.

Also, the second segment 322 may include at least one capsule 34. Here, the capsule 34 may perform a function of generating flavor. The capsule 34 may also perform a function of generating an aerosol. For example, the capsule 34 may have a structure in which a liquid containing a flavoring material is wrapped with a film. The capsule 34 may have a spherical or cylindrical shape, but is not limited thereto.

The first wrapper 351 may be made by coupling a metal foil, such as aluminum foil, to general filter wrapping paper. For example, a total thickness of the first wrapper 351 may be in a range of 45 μm to 55 μm. For example, the total thickness of the first wrapper 351 may be 50.3 μm. In addition, a thickness of the metal foil of the first wrapper 351 may be in a range of 6 μm to 7 μm. For example, the thickness of the metal foil of the first wrapper 351 may be 6.3 μm. In addition, a basis weight of the first wrapper 351 may be in a range of 50 g/m² to 55 g/m². For example, the basis weight of the first wrapper 351 may be 53 g/m².

The second wrapper 352 and the third wrapper 353 may be made of general filter wrapping paper. For example, the second wrapper 352 and the third wrapper 353 may be porous wrappers or non-porous wrappers.

For example, porosity of the second wrapper 352 may be 35000 CU, but is not limited thereto. In addition, a thickness of the second wrapper 352 may be in a range of 70 μm to 80 μm. For example, the thickness of the second wrapper 352 may be 78 μm. In addition, a basis weight of the second wrapper 352 may be in a range of 20 g/m² to 25 g/m². For example, the basis weight of the second wrapper 352 may be 23.5 g/m².

For example, porosity of the third wrapper 353 may be 24000 CU, but is not limited thereto. In addition, a thickness of the third wrapper 353 may be in a range of 60 μm to 70 μm. For example, the thickness of the third wrapper 353 may be 68 μm. In addition, a basis weight of the third wrapper 353 may be in a range of 20 g/m² to 25 g/m². For example, the basis weight of the third wrapper 353 may be 21 g/m².

The fourth wrapper 354 may be made of PLA laminated paper. Here, the PLA laminated paper may refer to a three-layer paper consisting of a paper layer, a PLA layer, and a paper layer. For example, a thickness of the fourth wrapper 354 may be in a range of 100 μm to 120 μm. For example, the thickness of the fourth wrapper 354 may be 110 μm. In addition, a basis weight of the fourth wrapper 354 may be in a range of 80 g/m² to 100 g/m². For example, the basis weight of the fourth wrapper 354 may be 88 g/m².

The fifth wrapper 355 may be made of sterile paper (MFW). Here, the sterile paper (MFW) may refer to paper specially designed to have improved tensile strength, water resistance, smoothness, and the like compared to general paper. For example, a basis weight of the fifth wrapper 355 may be in a range of 57 g/m² to 63 g/m². For example, the basis weight of the fifth wrapper 355 may be 60 g/m². In addition, a thickness of the fifth wrapper 355 may be in a range of 64 μm to 70 μm. For example, the thickness of the fifth wrapper 355 may be 67 μm.

A predetermined material may be added into the fifth wrapper 355. Here, an example of the predetermined material may be silicone, but is not limited thereto. For example, silicone has properties such as heat resistance with little change with temperature, oxidation resistance, resistance to various chemicals, water repellency to water, electrical insulation, etc. However, other than the silicone, any material having the above-described properties may be applied (or coated) onto the fifth wrapper 355.

The front-end plug 33 may be made of cellulose acetate. In one example, the front-end plug 33 may be made by adding a plasticizer (e.g., triacetin) to cellulose acetate tow. A mono denier of a filament constituting the cellulose acetate tow may be in a range of 1.0 to 10.0. For example, the mono denier of the filament constituting the cellulose acetate tow may be in a range of 4.0 to 6.0. For example, a mono denier of a filament of the front-end plug 33 may be 5.0. In addition, a cross section of the filament of the front-end plug 33 may be a Y-shape. A total denier of the front-end plug 33 may be in a range of 20000 to 30000. For example, the total denier of the front-end plug 33 may be in a range of 25000 to 30000. For example, the total denier of the front-end plug 33 may be 28000.

In addition, when necessary, the front-end plug 33 may include at least one channel. A shape of a cross section of the channel of the front-end plug 330 may be formed in various ways.

The tobacco rod 31 may correspond to the tobacco rod 21 described above with reference to FIG. 5. Therefore, a detailed description of the tobacco rod 31 will be omitted.

The first segment 321 may be made of cellulose acetate. For example, the first segment may be a tube-shaped structure including a hollow therein. The first segment 321 may be made by adding a plasticizer (e.g., triacetin) to cellulose acetate tow. For example, a mono denier and a total denier of the first segment 321 may be the same as the mono denier and the total denier of the front-end plug 33.

The second segment 322 may be made of cellulose acetate. A mono denier of a filament of the second segment 322 may be in a range of 1.0 to 10.0. For example, the mono denier of the filament of the second segment 322 may be in a range of 8.0 to 10.0. For example, the mono denier of the filament of the second segment 322 may be 9.0. In addition, a cross section of the filament of the second segment 322 may be a Y-shape. A total denier of the second segment 322 may be in a range of 20000 to 30000. For example, the total denier of the second segment 322 may be 25000.

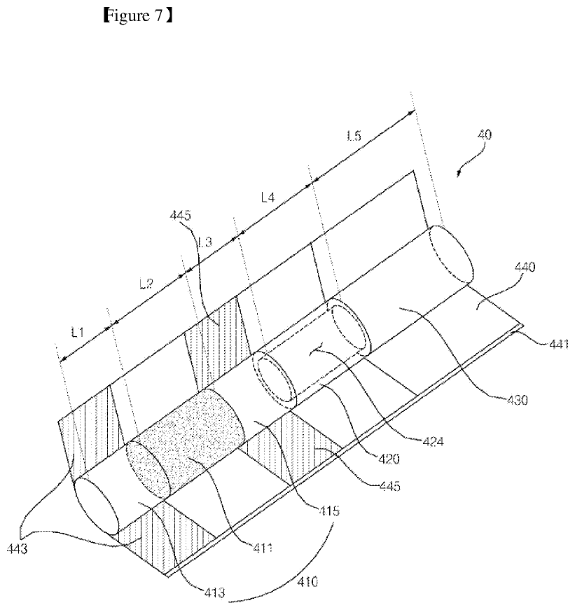

Referring to FIG. 7, a stick 40 may include a medium portion 410. The stick 40 may include a cooling portion 420. The stick 40 may include a filter portion 430.

The cooling portion 420 may be disposed between the medium portion 410 and the filter portion 430. The stick 40 may include a wrapper 440. The wrapper 440 may wrap the medium portion 410. The wrapper 440 may wrap the cooling portion 420. The wrapper 440 may wrap the filter portion 430. The stick 40 may have a cylindrical shape.

The medium portion 410 may include a medium 411. The medium portion 410 may include a first support portion 413. The medium portion 410 may include a second support portion 415. The medium 411 may be disposed between the first support portion 413 and the second support portion 415. The first support portion 413 may be disposed at one end of the stick 40. The medium portion 410 may have a length of 24 μmm.

The medium 411 may contain a multicomponent substance. The substance contained in the medium may be a multicomponent flavoring substance. The medium 411 may be composed of a plurality of granules. Each of the plurality of granules may have a size of 0.4 μmm to 1.12 μmm. The granules may account for approximately 70% of the volume of the medium 411. A length L2 of the medium 411 may be 10 μmm. The first support portion 413 may be made of a paper material. The second support portion 415 may be made of a paper material. The first support portion 413 may be made of an acetate material. The second support portion 415 may be made of an acetate material. At least one of the first support portion 413 and the second support portion 415 may be made of a paper material to be crumpled with wrinkles, and a plurality of gaps may be formed between the wrinkles to allow air to flow therethrough. Each of the gaps may be smaller than each of the granules of the medium 411. A length L1 of the first support portion 413 may be less than the length L2 of the medium 411. A length L3 of the second support portion 415 may be less than the length L2 of the medium 411. The length L1 of the first support portion 413 may be 7 μmm. The length L2 of the second support portion 415 may be 7 μmm.

Accordingly, each of the granules of the medium 411 may be prevented from being separated from the medium portion 410 and the stick 40.

The cooling portion 420 may have a cylindrical shape. The cooling portion 420 may have a hollow shape. The cooling portion 420 may be disposed between the medium portion 410 and the filter portion 430. The cooling portion 420 may be disposed between the second support portion 415 and the filter portion 430. The cooling portion 420 may be formed in the shape of a tube that surrounds a cooling path 424 formed therein. The cooling portion 420 may be thicker than the wrapper 440. The cooling portion 420 may be made of a paper material thicker than that of the wrapper 440. A length L4 of the cooling portion 420 may be equal or similar to the length L2 of the medium 411. The length L4, which is the length of the cooling portion 420 and the cooling path 424, may be 10 μmm. When the stick 40 is inserted into the aerosol generating device 10, at least a portion of the cooling portion 420 may be exposed to an outside of the aerosol generating device 10.

Accordingly, the cooling portion 420 may support the medium portion 410 and the filter portion 430, and may achieve the rigidity of the stick 40. In addition, the cooling portion 420 may support the wrapper 440 between the medium portion 410 and the filter portion 430, and may provide a portion to which the wrapper 440 is adhered. In addition, heated air and aerosol may be cooled while passing through the cooling path 424 in the cooling portion 420.

The filter portion 430 may be configured as a filter made of an acetate material. The filter portion 430 may be disposed at another end of the stick 40. When the stick 40 is inserted into the aerosol generating device 10, the filter portion 430 may be exposed to the outside of the aerosol generating device 10. A user may inhale air while holding the filter portion 430 in his or her mouth. A length L5 of the filter portion 430 may be 14 μmm.

The wrapper 440 may wrap or surround the medium portion 410, the cooling portion 420, and the filter portion 430. The wrapper 440 may define an outer appearance of the stick 40. The wrapper 440 may be made of a paper material. An adhesive portion 441 may be formed along one edge of the wrapper 440. The wrapper 440 may surround the medium portion 410, the cooling portion 420 and the filter portion 430, and the adhesive portion 441 formed along the one edge of the wrapper 440 and another edge of the wrapper 440 may be adhered to each other. The wrapper 440 may surround the medium portion 410, the cooling portion 420, and the filter portion 430, but may not cover one end and another end of the stick 40.

Accordingly, the wrapper 440 may fix the medium portion 410, the cooling portion 420, and the filter portion 430, and may prevent these components from being separated from the stick 40.

A first thin film 443 may be disposed at a position corresponding to the first support portion 413. The first thin film 443 may be disposed between the wrapper 440 and the first support portion 413, or may be disposed outside the wrapper 440. The first thin film 443 may surround the first support portion 413. The first thin film 443 may be made of a metal material. The first thin film 443 may be made of an aluminum material. The first thin film 443 may be in close contact with or coated on the wrapper 440.

A second thin film 445 may be disposed at a position corresponding to the second support portion 415. The second thin film 445 may be disposed between the wrapper 440 and the second support portion 415, or may be disposed outside the wrapper 440. The second thin film 445 may be made of a metal material. The second thin film 445 may be made of an aluminum material. The second thin film 445 may be in close contact with or coated on the wrapper 440.

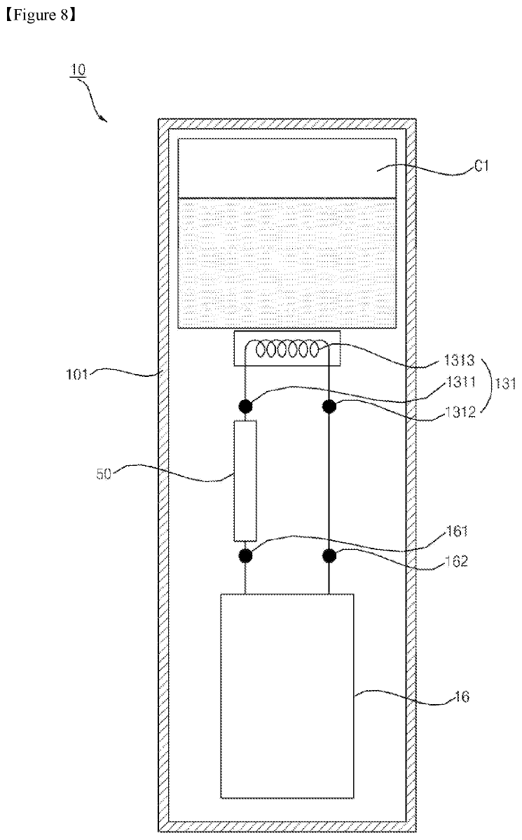

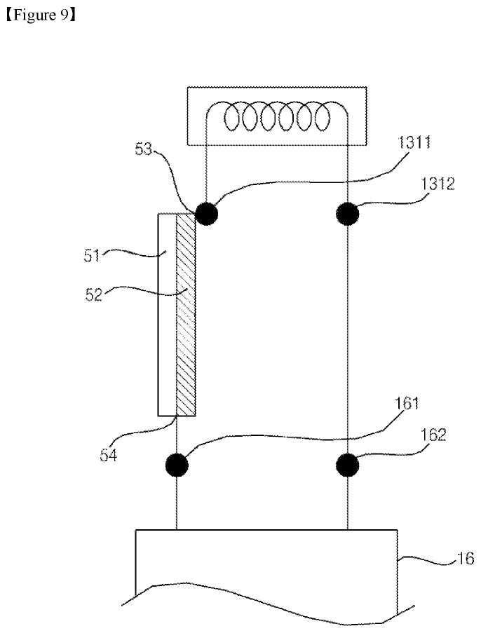

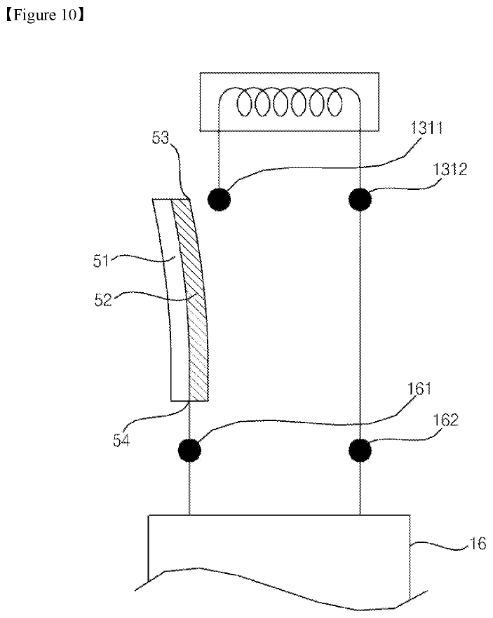

FIG. 8 is a view illustrating a structure of an aerosol generating device, according to an embodiment of the present disclosure, and FIGS. 9 and 10 are views for explaining the aerosol generating device.

Referring to FIGS. 8 to 10, the aerosol generating device 10 may include a chamber C1, a heater 131, a battery 16, and a temperature switch 50.

A housing 101 of the aerosol generating device 10 may be provided therein with the chamber C1 in which an aerosol generating substance is stored. A flow path in communication with the chamber C1 and through which the aerosol generating substance flows may be provided at one side of the chamber C1. The flow path may be provided therein with a wick (not shown) impregnated with (containing) an aerosol generating substance. The aerosol generating substance in the chamber C1 may be impregnated into the wick. For example, the wick may include a cotton fiber, a ceramic fiber, a glass fiber, a porous ceramic, etc.

The heater 131 may include a coil 1313 surrounding the wick, a first heater terminal 1311 connected to one end of the coil 1313, and a second heater terminal 1312 connected to another end of the coil 1313. The heater 131 may be disposed adjacent to one end of the chamber C1. The heater 131 may heat an aerosol generating substance impregnated in the wick, which has flown from the chamber C1 to the wick.

The battery 16 may be electrically connected to the heater 131 to thereby supply power to the heater 131. The battery 16 may include a first battery terminal 161 and a second battery terminal 162. The first battery terminal 161 and the second battery terminal 162 may be electrically connected to both ends of the coil 1313 of the heater 131, respectively. As a voltage between the first battery terminal 161 and the second battery terminal 162 is applied to the both ends of the coil 1313, power may be supplied to the heater 131 from the battery 16.

The temperature switch 50 may be electrically connected to the heater 131 and the battery 16.

Referring to FIG. 9, the temperature switch 50 may be electrically connected to the heater 131 and the battery 16. The temperature switch 50 may have an elongated shape, and may be provided with a switch terminal at each of both ends in its longitudinal direction. The temperature switch 50 may have a first switch terminal 53 at one end thereof in the longitudinal direction, and a second switch terminal 54 at another end thereof in the longitudinal direction. The first switch terminal 53 of the temperature switch 50 may be in contact with (electrically coupled to) the first heater terminal 1311. The second switch terminal 54 may be electrically connected to the first battery terminal 161 of the battery 161.

The first switch terminal 53 of the temperature switch 50 may be disposed inside the housing 101 in the form of a free end to achieve contact and non-contact with the first heater terminal 1311. The second switch terminal 54 of the temperature switch 50 may be electrically connected to the first battery terminal 161, and may be fixed inside the housing 101.

Referring to FIG. 10, the first switch terminal 53 of the temperature switch 50 may be disposed adjacent to the coil 1313 of the heater 131. When the heater 131 is heated as power is supplied to the heater 131 from the battery 16, the temperature switch 50 may be heated together with the heater 131. The temperature switch 50 may be heated to a temperature of the coil 1313 or a temperature close to the temperature of the coil 1313. The temperature switch 50 may be bent in one direction as the temperature switch 50 is heated and the temperature increases accordingly. For example, when the temperature switch 50 is heated to or above a first temperature (temperature threshold), the temperature switch 50 may be bent in the one direction. Here, the first temperature may be determined according to a metal component constituting the temperature switch 50.

As the temperature switch 50 is bent in the one direction, the first switch terminal 53 may be spaced apart from the first heater terminal 1311. The first switch terminal 53 may be electrically open with respect to the first heater terminal 1311.

The temperature switch 50 may include two or more metal plates. For example, the temperature switch 50 may include a first plate 51 comprising a first metal and a second plate 52 comprising a second metal. The first plate 51 may be made of the first metal and the second plate 52 may be made of the second metal. One surface of the first plate 51 and one surface of the second plate 52 may be in contact with each other.

Both ends of the first plate 51 may be connected to the first switch terminal 53 and the second switch terminal 54, respectively, and both ends of the second plate 52 in contact with the first plate 51 may be connected to the first switch terminal 53 and the second switch terminal 54, respectively. For example, the first switch terminal 53 and the second switch terminal 54 may be electrically connected to both ends of the first plate 51 and both ends of the second plate 52, and may be made of any one of the first metal and the second metal, which respectively constitute the first plate 51 and the second plate 52. Meanwhile, the first switch terminal 53 and the second switch terminal 54 may be portions of the first plate 51 and/or the second plate 52. In this case, one end of the first plate 51 or one end of the second plate 52 may be the first switch terminal 53, and another end of the first plate 51 or another end of the second plate 52 may be the second switch terminal 54.

The first metal and the second metal may have different coefficients of thermal expansion. For example, the coefficient of thermal expansion of the first metal may have a larger value than the coefficient of thermal expansion of the second metal. For example, the coefficient of thermal expansion of the first metal may have a smaller value than the coefficient of thermal expansion of the second metal.

For example, the first metal may be copper (Cu), and the second metal may be iron (Fe). For example, the first metal may be an alloy of nickel (Ni), iron (Fe) and manganese (Mn), an alloy of nickel (Ni), iron (Fe), and molybdenum (Mo), or an alloy of nickel (Ni), manganese (Mn) and copper (Cu), and the second metal may be an alloy of nickel (Ni) and iron (Fe). However, the types of the first metal and the second metal are not limited thereto.

When the temperature of the temperature switch 50 increases, the temperature switch 50 may be bent in one direction due to different degrees of expansion of the first plate 51 and the second plate 52. For example, when the coefficient of thermal expansion of the first metal is greater than the coefficient of thermal expansion of the second metal, the temperature switch 50 may be bent in a direction in which the second plate 52 is located as the temperature rises. For example, when the coefficient of thermal expansion of the first metal is less than the coefficient of thermal expansion of the second metal, the temperature switch 50 may be bent in a direction in which the first plate 51 is located as the temperature rises.

The first temperature may be a temperature higher than a vaporization temperature of the aerosol generating substance. In a state where the first switch terminal 53 of the temperature switch 50 is in contact with the first heater terminal 1311, the heater 131 may be heated by receiving power from the battery 16. The heater 131 may be heated to a temperature above the vaporization temperature of the aerosol generating substance. When the heater 131 is heated to the temperature above the vaporization temperature of the aerosol generating substance, the aerosol generating substance in the wick may be vaporized by the heat of the heater 131.

The first temperature may be a temperature equal to or lower than a set temperature. Here, the set temperature may be a temperature of the heater 131 in a state where the aerosol generating substance impregnated in the wick is all or completely vaporized and exhausted. The set temperature may be a temperature higher than the vaporization temperature of the aerosol generating substance. When the aerosol generating substance contained in the wick is all vaporized while no additional aerosol generating substance is supplied to the wick, the temperature of the heater 131 may increase rapidly. Accordingly, the set temperature may be set to a temperature at which the temperature of the heater 131 starts to increase after vaporizing all of the aerosol generating substance contained in the wick. For example, the set temperature may be a temperature 5 degrees or 10 degrees higher than the vaporization temperature of the aerosol generating substance. However, the set temperature is not limited thereto, and may be set based on experimental data and the like.

As the temperature switch 50 switches electrical connection between the heater 131 and the battery 16 based on the first temperature, the heater 131 may be heated to a temperature equal to or higher than the vaporization temperature of the aerosol generating substance, allowing the aerosol generating substance to vaporize.

In addition, when the heater 131 is heated up to a temperature higher than the vaporization temperature of the aerosol generating substance by a predetermined degree (the first temperature) as the aerosol generating substance is exhausted, electrical connection between the heater 131 and the battery 161 may be cut off to thereby prevent overheating of the heater 131.

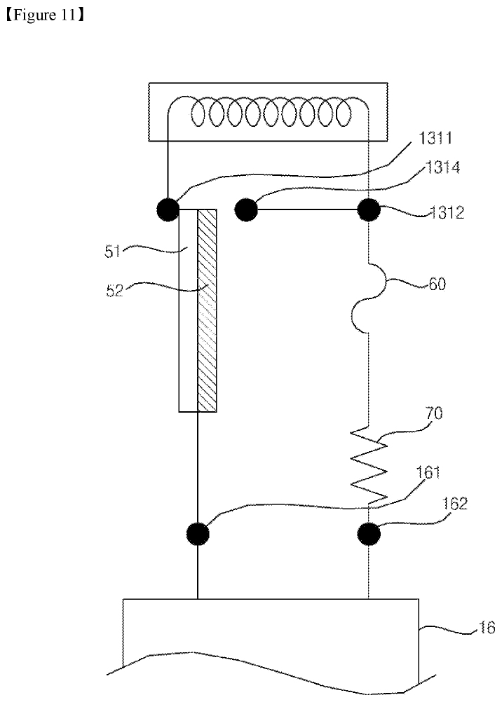

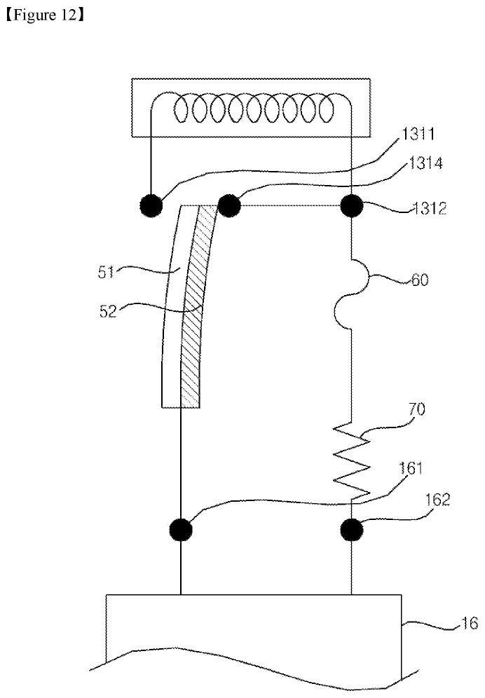

FIGS. 11 and 12 are views for explaining the aerosol generating device. A detailed description overlapping the description in FIGS. 9 and 10 will be omitted.

Referring to FIGS. 11 and 12, a fuse 60 may be electrically connected between the second heater terminal 1312 of the heater 131 and the second battery terminal 162 of the battery 16. Both ends of the fuse 60 may be connected to the second heater terminal 1312 and the second battery terminal 162, respectively. A first end of the fuse 60 may be coupled to the second heater terminal 1312 and a second end of the fuse 60 may be coupled to the second battery terminal 162.

The heater 131 may include a third heater terminal 1314. The third heater terminal 1314 may be electrically connected to the second heater terminal 1312. For example, the third heater terminal 1314 may be connected to the second heater terminal 1312 through a conductive wire. For example, the third heater terminal 1314 may be connected to the second heater terminal 1312 through a pattern of a PCB circuit.

The third heater terminal 1314 may be disposed adjacent to the first switch terminal 53 of the temperature switch 50.

Referring to FIG. 11, at a temperature below the first temperature, the first switch terminal 53 of the temperature switch 50 may be in contact with the first heater terminal 1311.

Referring to FIG. 12, the coefficient of thermal expansion of the first metal of the first plate 51 of the temperature switch 50 may be greater than the coefficient of thermal expansion of the second metal of the second plate 52 of the temperature switch 50. In this case, when the temperature switch 50 is heated to or above the first temperature, the temperature switch 50 may be bent in one direction. As a result, the first switch terminal 53 may be brought into contact with the third heater terminal 1314 to be electrically connected to the heater terminal 1314.

The fuse 60 may be electrically open when a current flowing through the fuse 60 is greater than or equal to a predetermined value. A threshold current at which the fuse 60 is electrically open may be referred to as a cut-off current. For example, the fuse 60 may be blown when a current with the magnitude higher than the magnitude of the cut-off current flows. When the fuse 60 is blown, both ends of the fuse 60 may be electrically and permanently open.

When the first switch terminal 53 of the temperature switch 50 is electrically connected to the first heater terminal 1311 at a temperature below the first temperature, a first closed loop in which the battery 16, the temperature switch 50, the heater 131, and the fuse 60 are connected in series may be formed.

When the first switch terminal 53 of the temperature switch 50 is electrically connected to the third heater terminal 1314 at a temperature greater than or equal to the first temperature, a second closed loop in which the battery 16, the temperature switch 50, and the fuse 60 are connected in series may be formed.

In the first closed loop, a current with the magnitude lower than that of the cut-off current may flow through the fuse 60. In the second closed loop, a current with the magnitude equal to or higher than that of the cut-off current may flow through the fuse 60. As the resistance due to the heater 131 does not exist in the second closed loop, compared to the first closed loop, the magnitude of the current flowing through the second closed loop may be greater the magnitude of the current flowing through the first closed loop.

When the first switch terminal 53 is electrically connected to the third heater terminal 1314, a current greater than or equal to the cut-off current may flow through the fuse 60. Accordingly, the fuse 60 may be electrically open (blown), the heater 131 may be electrically open with respect to the battery 16, and power supplied to the heater 131 from the battery 16 may be cut off.

When the fuse 60 is electrically open (blown), the heater 131 and the battery 16 are not electrically connected unless the fuse 60 is replaced. Accordingly, even when the temperature of the temperature switch 50 decreases below the first temperature, the heater 131 may be maintained in the state of being electrically open with respect to the battery 16, and power supplied to the heater 131 from the battery 16 may be cut off.

Meanwhile, the fuse 60 and a protection resistor 70 may be electrically connected between the second heater terminal 1312 of the heater 131 and the second battery terminal 162 of the battery 16. The fuse 60 and the protection resistor 70 may be connected in series between the second heater terminal 1312 and the second battery terminal 162.

When the first switch terminal 53 of the temperature switch 50 is electrically connected to the first heater terminal 1311 at a temperature below the first temperature, a third closed loop in which the battery 16, the temperature switch 50, the heater 131, the fuse 60, and the protection resistor 70 are connected in series may be formed.

When the first switch terminal 53 of the temperature switch 50 is electrically connected to the third heater terminal 1314 at a temperature greater than or equal to the first temperature, a fourth closed loop in which the battery 16, the temperature switch 50, the fuse 60, and the protection resistor 70 are connected in series may be formed.

In the third closed loop, a current with the magnitude lower than that of the cut-off current may flow through the fuse 60. In the fourth closed loop, a current with the magnitude equal to or higher than that of the cut-off current may flow through the fuse 60.

As in the case of the second closed loop, when the temperature switch 50 and the fuse 60 are only connected to the battery 16, the magnitude of the current flowing through the second closed loop may be higher than necessary. In this case, a cut-off current with a high magnitude should be used for the fuse 60, and the possibility of damage to the battery 16 may exist. As the protection resistor 70 is further connected to the fuse 60 in series in the fourth closed loop, the magnitude of the current flowing through the fourth closed loop may be set within an appropriate range due to the magnitude of the protection resistor 70.

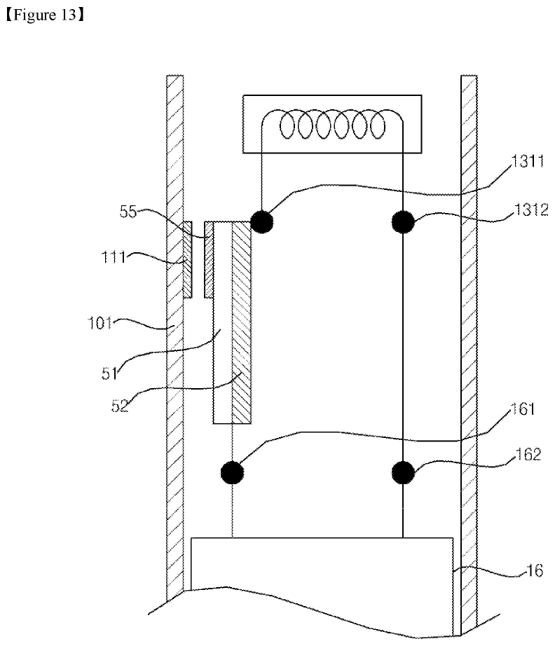

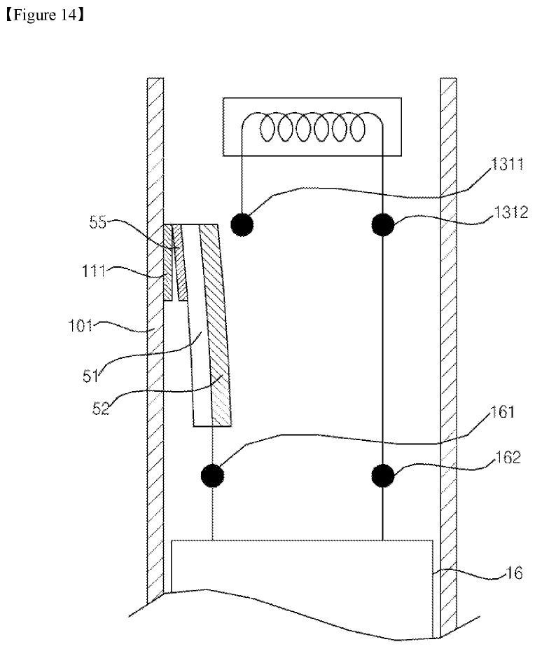

FIGS. 13 and 14 are views for explaining the aerosol generating device. A detailed description overlapping the description in FIGS. 9 and 10 will be omitted.

Referring to FIGS. 13 and 14, a first adhesive portion 55 may be provided at one side of the temperature switch 50. For example, the first plate 51 of the temperature switch 50 may be disposed adjacent to one surface of the housing 101, and the first adhesive portion 55 may be provided on a surface of the first plate 51 that is disposed adjacent to the one surface of the housing 101. An adhesive may be applied to the first adhesive portion 55, or the first adhesive portion 55 may contain an adhesive.

A second adhesive portion 111 may be provided on one surface of the housing 101. The second adhesive portion 111 may be provided on a surface of the housing 101 that is disposed adjacent to the first plate 51. With respect to the longitudinal direction of the temperature switch 50 (a direction from the first heater terminal 1311 to the first battery terminal 161), the second adhesive portion 111 may be disposed at a position corresponding to a position at which the first adhesive portion 55 is provided.

An adhesive may be applied to the second adhesive portion 111, or the second adhesive portion 111 may contain an adhesive. A portion of the second adhesive portion 111 applied with or containing the adhesive may be disposed opposite a portion of the first adhesive portion 55 applied with or containing the adhesive.

The coefficient of thermal expansion of the first metal of the first plate 51 of the temperature switch 50 may be less than the coefficient of thermal expansion of the second metal of the second plate 52 of the temperature switch 50. In this case, when the temperature switch 50 is heated to or above the first temperature, the temperature switch 50 may be bent in a direction in which the second adhesive portion 111 is disposed. As a result, the first adhesive portion 55 and the second adhesive portion 111 may be brought into contact with each other.

When the temperature switch 50 is heated to or above the first temperature, the first adhesive portion 55 and the second adhesive portion 111 may be brought into contact with each other, allowing the temperature switch 50 to be fixed while being in contact with the one surface of the housing 101. Accordingly, even when the temperature of the temperature switch 50 decreases below the first temperature, the heater 131 may be maintained in the state of being electrically open with respect to the battery 16, and power supplied to the heater 131 from the battery 16 may be cut off.

As described above, according to at least one of the embodiments of the present disclosure, the supply of power to a heater may be cut off based on the remaining amount of aerosol generating substance.

According to at least one of the embodiments of the present disclosure, overheating of a heater may be prevented when the remaining amount of aerosol generating substance is insufficient.

Referring to FIGS. 1 to 14, an aerosol generating device 10 according to one aspect of the present disclosure may include: a housing 101; a heater 131 configured to heat an aerosol generating substance; a battery 16 configured to supply power to the heater 131; and a temperature switch 50 configured to switch an electrical connection between the heater 131 and the battery 16. The temperature switch 50 may include a first switch terminal 53 that is positioned to electrically couple to a first heater terminal 1311 of the heater 131 and a second switch terminal 54 that is positioned to electrically couple to a first battery terminal 161 of the battery 16, and the temperature switch 50 may be bent in a direction when the temperature switch 50 is heated to or above a first temperature. The first switch terminal 53 may be spaced apart from the first heater terminal 1311 after the temperature switch 50 is bent in the direction to electrically open the coupling of the first switch terminal 53 to the first heater terminal 1311.

According to another aspect of the present disclosure, the first temperature may be higher than a vaporization temperature of the aerosol generating substance.

According to another aspect of the present disclosure, the temperature switch 50 may include: a first plate 51 comprising a first metal and extending from the first battery terminal 161 in a direction toward the first heater terminal 1311; and a second plate 52 comprising a second metal and having one surface in contact with one surface of the first plate 51. A coefficient of thermal expansion of the first metal may be different from a coefficient of thermal expansion of the second metal.

According to another aspect of the present disclosure, the aerosol generating device 10 may further include a fuse 60 having first and second ends. The heater 131 may include: a coil 1313 having one end coupled to the first heater terminal 1311; and a second heater terminal 1312 coupled to another end of the coil 1313. The battery 16 may include a second battery terminal 162. The first end of the fuse 60 may be coupled to the second heater terminal 1312 and the second end of the fuse 60 may be coupled to the second battery terminal 162.

According to another aspect of the present disclosure, the heater 131 may further include a third heater terminal 1314 electrically connected to the second heater terminal 1312 and disposed adjacent to the first switch terminal 53.

According to another aspect of the present disclosure, the coefficient of thermal expansion of the first metal may be greater than the coefficient of thermal expansion of the second metal. The temperature switch 50 may be bent in the direction when the temperature switch 50 is heated to or above the first temperature, such that the first switch terminal 53 may be brought into electrical contact with the third heater terminal 1314 to be electrically coupled to the third heater terminal 1314.

According to another aspect of the present disclosure, the fuse 60 may be electrically open when a current greater than or equal to a cut-off current flows. When the first switch terminal 53 is electrically coupled to the third heater terminal 1314, a current greater than or equal to the cut-off current may flow through the fuse 60.

According to another aspect of the present disclosure, the aerosol generating device 10 may further include a protection resistor 70. The fuse 60 and the protection resistor 70 may be connected in series between the second heater terminal 1312 and the second battery terminal 162.

According to another aspect of the present disclosure, the coefficient of thermal expansion of the first metal may be less than the coefficient of thermal expansion of the second metal. A first adhesive portion 55 may be provided on at least a portion of another surface of the first plate 51.

According to another aspect of the present disclosure, the housing 101 may include a second adhesive portion 111 on one surface disposed adjacent to the another surface of the first plate 51. The temperature switch 50 may be bent in a direction in which the second adhesive portion 111 is disposed when the temperature switch 50 is heated to or above the first temperature, such that the first adhesive portion 55 and the second adhesive portion 111 may be brought into contact.

An aerosol generating device 10 according to another aspect of the present disclosure may include: a heater 131 configured to heat an aerosol generating substance; a battery 16 configured to supply power to the heater 131 to enable the heater 131 to heat the aerosol generating substance; a temperature switch 50 configured to switch an electrical connection between the heater 131 and the battery 16; and a housing 101 that is shaped to include the heater 131, the battery 16 and the temperature switch 50, wherein the temperature switch 50 comprises: a first switch terminal 53 electrically coupled to a first heater terminal 1311 of the heater 131 when the temperature switch 50 is in a first orientation; and a second switch terminal 54 that is positioned to electrically couple to a first battery terminal 161 of the battery 16 when the temperature switch 50 is in the first orientation, wherein the temperature switch 50 is bent, relative to the first orientation, when the temperature switch 50 is heated to exceed a temperature threshold, and wherein while the temperature switch 0 is bent, the first switch terminal 53 is spaced from the first heater terminal 1311 to electrically open the coupling of the first switch terminal 53 to the first heater terminal 1311.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. An aerosol generating device comprising:
a housing;
a heater configured to heat an aerosol generating substance;
a battery configured to supply power to the heater; and
a temperature switch configured to switch an electrical connection between the heater and the battery,
wherein the temperature switch comprises:
a first switch terminal that is positioned to electrically couple to a first heater terminal of the heater; and
a second switch terminal that is positioned to electrically couple to a first battery terminal of the battery,
wherein the temperature switch is bent in a direction when the temperature switch is heated to or above a first temperature, and
wherein the first switch terminal is spaced apart from the first heater terminal after the temperature switch is bent in the direction to electrically open the coupling of the first switch terminal to the first heater terminal.

2. The aerosol generating device of claim 1, wherein the first temperature is higher than a vaporization temperature of the aerosol generating substance.

3. The aerosol generating device of claim 1, wherein the temperature switch further comprises:
a first plate comprising a first metal and extending from the first battery terminal in a direction toward the first heater terminal; and
a second plate comprising a second metal and having one surface in contact with one surface of the first plate, and
wherein a coefficient of thermal expansion of the first metal is different from a coefficient of thermal expansion of the second metal.

4. The aerosol generating device of claim 3, further comprising a fuse having first and second ends,
wherein the heater comprises:
a coil having one end coupled to the first heater terminal; and
a second heater terminal coupled to another end of the coil,
wherein the battery comprises a second battery terminal, and
wherein the first end of the fuse is coupled to the second heater terminal and the second end of the fuse is coupled to the second battery terminal.

5. The aerosol generating device of claim 4, wherein the heater further comprises a third heater terminal electrically connected to the second heater terminal and disposed adjacent to the first switch terminal.

6. The aerosol generating device of claim 5, wherein the coefficient of thermal expansion of the first metal is greater than the coefficient of thermal expansion of the second metal, and
wherein the temperature switch is bent in the direction when the temperature switch is heated to or above the first temperature, such that the first switch terminal is brought into electrical contact with the third heater terminal to be electrically coupled to the third heater terminal.

7. The aerosol generating device of claim 5, wherein the fuse is electrically open when a current greater than or equal to a cut-off current flows, and
wherein when the first switch terminal is electrically coupled to the third heater terminal, a current greater than or equal to the cut-off current flows through the fuse.

8. The aerosol generating device of claim 5, further comprising a protection resistor,
wherein the fuse and the protection resistor are connected in series between the second heater terminal and the second battery terminal.

9. The aerosol generating device of claim 3, wherein the coefficient of thermal expansion of the first metal is less than the coefficient of thermal expansion of the second metal, and
wherein a first adhesive portion is provided on at least a portion of another surface of the first plate.

10. The aerosol generating device of claim 9, wherein the housing comprises a second adhesive portion on one surface disposed adjacent to the another surface of the first plate, and
wherein the temperature switch is bent in a direction in which the second adhesive portion is disposed when the temperature switch is heated to or above the first temperature, such that the first adhesive portion and the second adhesive portion are brought into contact.

11. An aerosol generating device comprising:
a heater configured to heat an aerosol generating substance;
a battery configured to supply power to the heater to enable the heater to heat the aerosol generating substance;
a temperature switch configured to switch an electrical connection between the heater and the battery; and
a housing that is shaped to include the heater, the battery and the temperature switch,
wherein the temperature switch comprises:
a first switch terminal electrically coupled to a first heater terminal of the heater when the temperature switch is in a first orientation; and
a second switch terminal that is positioned to electrically couple to a first battery terminal of the battery when the temperature switch is in the first orientation,
wherein the temperature switch is bent, relative to the first orientation, when the temperature switch is heated to exceed a temperature threshold, and
wherein while the temperature switch is bent, the first switch terminal is spaced from the first heater terminal to electrically open the coupling of the first switch terminal to the first heater terminal.
